(19) United States
(12) Patent Application Publication
(10) Pub. No.: US 2014/0072297 A1
(43) Pub. Date: Mar. 13, 2014

(54) OPTICAL FIBER LOOPBACK ADAPTER

(71) Applicant: ADC Telecommunications, Inc., Berwyn, PA (US)

(72) Inventor: PATRICK J. THOMPSON, Prior Lake, MN (US)

(73) Assignee: ADC Telecommunications, Inc., Berwyn, PA (US)

(21) Appl. No.: 14/020,204

(22) Filed: Sep. 6, 2013

Related U.S. Application Data
(60) Provisional application No. 61/698,300, filed on Sep. 7, 2012.

(51) Int. Cl. H04B 10/073

(52) U.S. Cl. CPC H04B 10/0731
USPC 398/16

(57) ABSTRACT

A passive optical fiber loopback adapter includes a first transmission port, a second transmission port, a first reception port, and a second reception port. A non-switched optical device is connected to each of the ports. The non-switched optical device routes light signals from the first transmission port to an appropriate port, based on the wavelength of the light signal. For example, a transmission light signal having a first wavelength is routed automatically to the second transmission port. A test light signal having a second wavelength different than the first wavelength is routed automatically to the second reception port.

### CROSS-REFERENCE TO RELATED APPLICATIONS

The present application claims priority to U.S. Provisional Patent Application Ser. No. 61/698,300 filed Sep. 7, 2012, the disclosure of which is hereby incorporated by reference in its entirety.

### BACKGROUND

Loopback devices are used in optical fiber systems, such as the system of FIG. 1, to test the integrity of a fiber optic circuit. A fiber optic system 10 includes a transmitter/receiver 12, typically located at a data provider, and an end-user device 14 (such as a personal computer) located at an end user. A loopback device 16 may be located between the transmitter/receiver 12 and the end-user device 14. Light signals containing data are sent from the transmitter/receiver 12 to the end-user device 14 via a transmission line 18. Similar signals, called reception signals, are sent from the end-user device 14 to the transmitter/receiver 14 on a reception line 20. When it is desired to the test the integrity of the circuit, the loopback device 16 may be configured so as to connect the transmission line 18 directly to the reception line 20, via a loop 22 at the loopback device 16. Accordingly, a test signal sent via the transmission line 18 should be received back at the transmitter/receiver 12, via the loop 22 and the reception line 20. Inconsistencies in or an absence of the test signal may be indicative of a physical problem with that portion of the loop between the transmitter/receiver 12 and the loopback device 16. Of course, in this configuration, the portion of the circuit from the loopback device 16 to the end-user device 14 remains untested. This may be reconciled by locating the loopback device 16 closer to the end-user device 14, but this now places the loopback device 16 further from the transmitter/receiver 12 (and the technician performing the test). Also, locating a loopback device 16 proximate every end-user device 14 is impractical and likely cost-prohibitive, as loopback devices require a power source to operate the switch located in the device.

Additionally, multiple data providers may send and receive data across a single fiber optic circuit. Typically, however, data providers want to test their lengths of cable in isolation of the cables owned by a different data provider. To do this, then, the first provider's portion of the circuit should be isolated from the other data provider's as described above (that is, by switching the loopback device 16 to route a distinct test signal back to the transmitter/receiver 12 of the first data provider). This may be difficult for a number of reasons. For example, all or a portion of the service signals transmitted along the transmission line 18 and the reception line 20 may be affected, resulting in a loss or reduction in service. Additionally, the loopback device 16 may be located some distance from the source of the test signal, which is usually located at or proximate the transmitter/receiver 12. This may require travel by the technician to the site of the connection, or require a second technician located remotely to perform the switch. These and other issues increase the cost associated with testing the fiber optic circuit.

### SUMMARY

In one aspect, the technology relates a passive optical fiber loopback adapter including: a first transmission port; a second transmission port; a first reception port; a second reception port; and a non-switched optical device, wherein the non-switched optical device is adapted to route a transmission light signal from the first transmission port to the second transmission port, and wherein the non-switched optical device is adapted to route a reception light signal from the first reception port to the second reception, and wherein the non-switched optical device is adapted to route a test light signal from the first transmission port to the second reception port.

In another aspect, the technology relates to: a optical fiber loopback adapter including: a housing, wherein the housing includes: a non-switched optical device; a first transmission port and a second transmission port, each connected to the non-switched optical device such that a transmission light signal directed into the first transmission port is routed to the second transmission port by the non-switched optical device; and a first reception port and a second reception port, each connected to the non-switched optical device such that a reception light signal directed into the first reception port is routed to the second reception port by the non-switched optical device; and wherein a test light signal directed into the first transmission port is routed to the second reception port by the non-switched optical device.

A method of passively testing a fiber optic circuit with an optical fiber loopback adapter including a non-switched optical device, a first transmission port, a second transmission port, a first reception port, and a second reception port, the method including: receiving a light signal via the first transmission port; automatically routing the light signal to the second transmission port if the light signal includes a first wavelength; and automatically routing the light signal to the second reception port if the light signal includes a second wavelength different from the first wavelength, wherein in both routing operations, the light signal is routed through the non-switched optical device.

These and other features and advantages will be apparent from a reading of the following detailed description and a review of the associated drawings. It is to be understood that both the forgoing general description and the following detailed description are explanatory only and are not restrictive of the broad aspects of the disclosure.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of a fiber optic system.

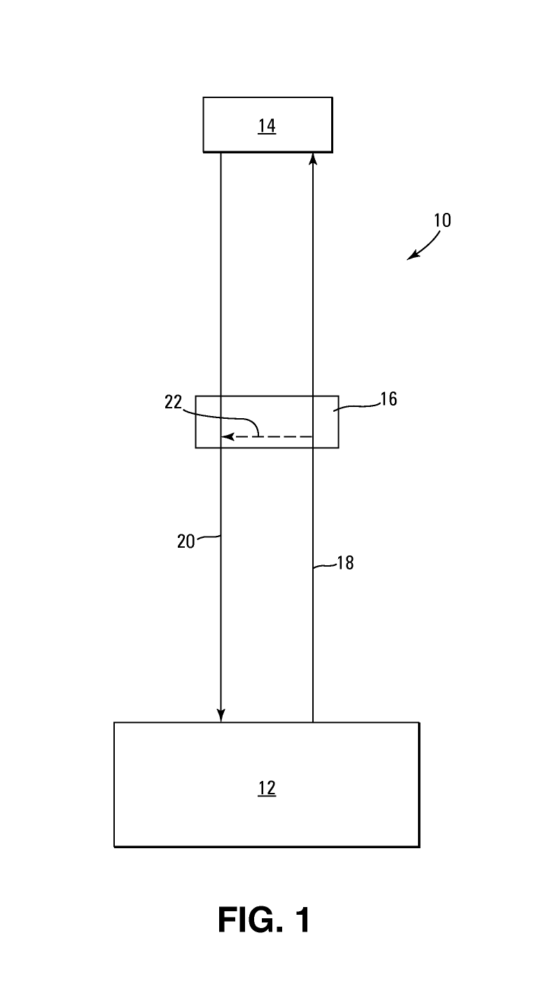

FIG. 2 is top sectional view of an optical fiber loopback adapter.

FIG. 3 is a partial top sectional view of the optical fiber loopback adapter of FIG. 2.

FIG. 4 is a perspective view of an optical fiber loopback adapter.

FIG. 5 depicts a method of passively testing a fiber optic circuit.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

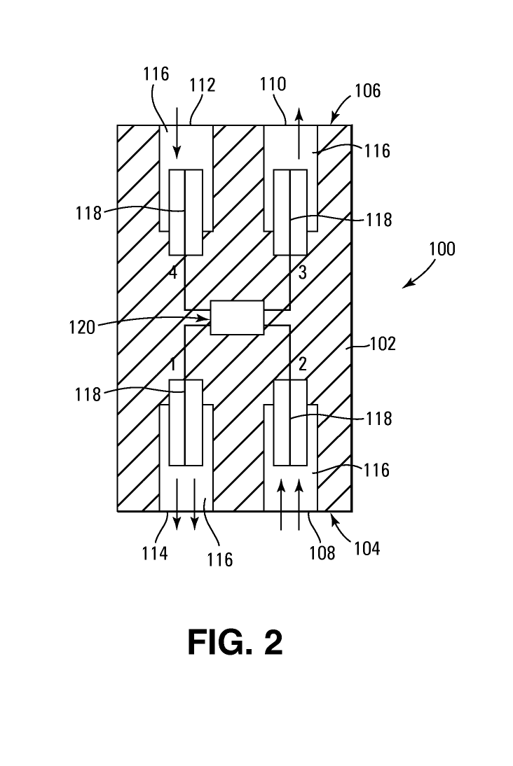

FIG. 2 is a top sectional view of a passive optical fiber loopback adapter 100. The adapter 100 has a housing 102 having a front portion 104 and a rear portion 106. Each of the front port 104 and the rear portion 106 define two ports. For clarity in this application, the ports are referred to as a first transmission port 108, a second transmission port 110, a first reception port 112, and a second reception port 114. Each of the ports includes a connector 116, which may be a standard ceramic split sleeve or other connection element for connecting a fiber optic cable connector to the adapter 100. The connectors 116 are each connected to a connectorized fiber 118 located within the housing 102. Each of the connectorized fibers 118 is routed to a non-switched optical device 120.

The non-switched optical device 120 is configured to allow light signals carried by the various optical fibers to be routed through the adapter 100. In general, for example, transmission signals sent from a data provider enter the adapter 100 via the first transmission port 108 and leave the adapter 100 to an end user via the second transmission port 110. Similarly, reception signals sent from the end user enter the adapter 100 via the first reception port 112 and leave the adapter 100 to the data provider via the second reception port 114. This configuration and routing of transmission and reception signals is typical for duplex adapters, such as the SC and LC adapters. Duplex adapters are regularly used in fiber optic systems to connect the circuits of different data providers. The ports of the loopback adapter 100 described herein are arranged so as to be similar to the arrangement of ports in duplex adapters. In this regard, the optical fiber loopback adapter 100 appears very similar to a duplex adapter and is therefore easy for technicians to incorporate into fiber optic systems.

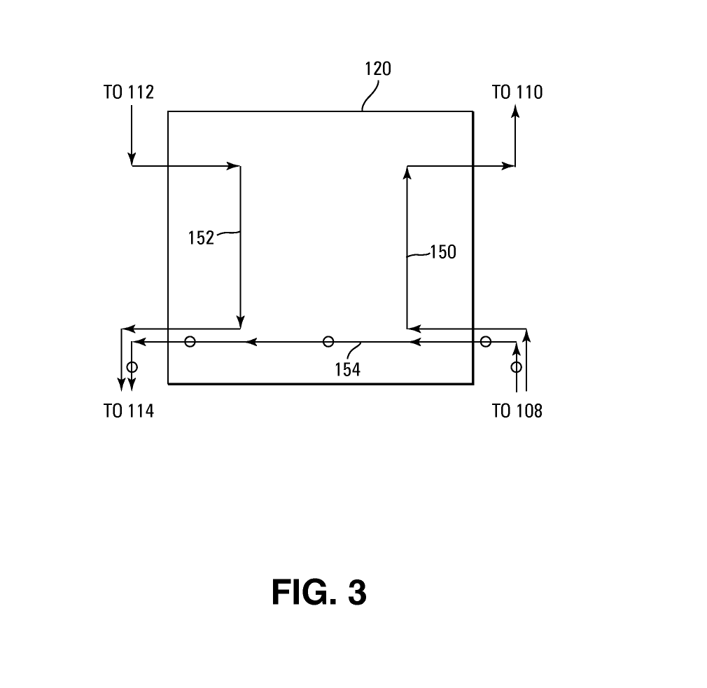

Further functionality of the adapter 100 is described below with regard to FIG. 3, which depicts and enlarged view of the signal routes through the non-switched optical device 120. The non-switched optical device 120 may be an optical beam splitter, a wavelength-division multiplexer, or other non-switched device. One advantage of a passive, non-switched device is that the adapter 100 need not be manipulated or actuated when a loopback test signal is directed to the adapter 100 so as to test the integrity of the fiber optic cable circuit. Since the passive device does not include a switch, it need not be powered nor actuated when tests are performed. This allows the connected circuit to be tested remotely, without access to the adapter 100. Additionally, the device is significantly easier to manufacture than switched loopback devices, and requires little if any operation costs, as it is not powered. Also, the passive, non-switched device is more reliable than switched devices, since no switch (which may be subject to failure) is present in the passive device.

In the embodiment depicted in FIG. 3, various signal routes are depicted. The transmission signal 150 is routed from the first transmission port 108, via the non-switched optical device 120, to the second transmission port 110. Similarly, the reception signal 152 is routed from the first reception port 112, via the non-switched optical device 120, to the second reception port 114. Each of the transmission signal 150 and the reception signal 152 may be a light beam having a predefined wavelength, such as about 1310 nm or about 1550 nm. These wavelengths are typical for transmission of data in fiber optic cable systems. Additionally, a test signal 154 may automatically be routed from the first transmission port 108 to the second reception port 114 (as depicted by the arrows including the “O” symbol). This test signal 154 may have a wavelength that differs from the transmission signal 150 and reception signal 152. In one embodiment, the test signal 154 may have a wavelength of about 1625 nm. This signal 154 is predefined and the optical device 120 programmed, set, or otherwise configured to automatically reroute a signal of that predetermined frequency from the first transmission port 108 to the second reception port 114.

The wavelengths of the transmission and reception signals, as well as that of the test signal may be set as required for a particular application. By delivering the test signal through an optical fiber connected to the first transmission port 108, the integrity of the optical fiber loop may be determined by sensing any signal received back from the second reception port. An absence of a returned test signal, or a returned test signal having unexpected parameters, would be indicative of a fault within the fiber optic circuit.

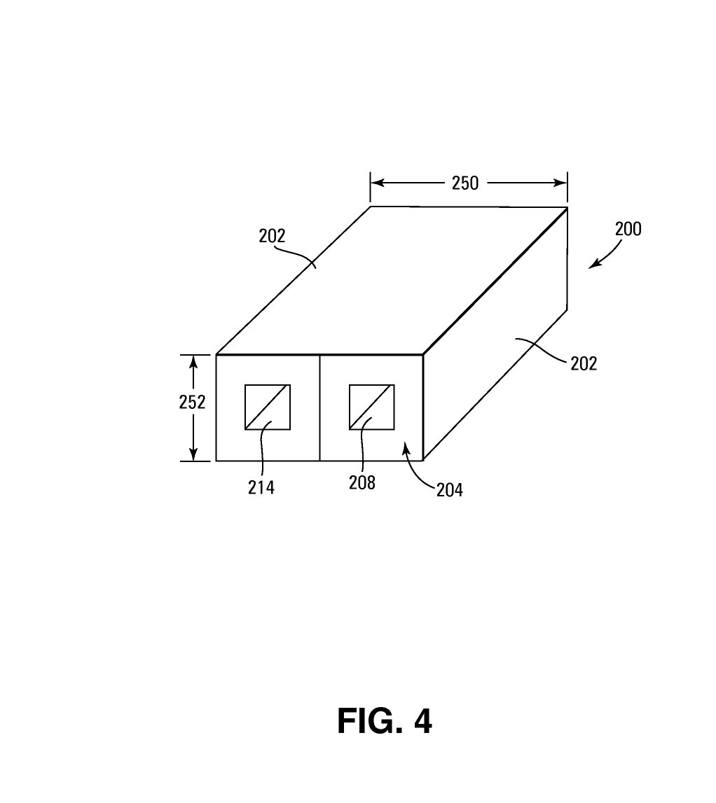

FIG. 4 depicts a perspective view of a fiber optic loopback adapter 200, which has dimensions similar to those of an SC or LC adapter, as described above. As with the embodiment of FIGS. 2 and 3, the fiber optic loopback adapter 200 includes a housing 202 having a front face 204 that defines a first transmission port 208 and a second reception port 214. The adapter 200 includes a horizontal dimension 250 and a vertical dimension 252, which may be similar to those of an SC or LC adapter. This allows the optical loopback adapter 200 to appear similar to a standard adapter (and thus a technician would find the configuration of the connection ports readily apparent). Of course, other dimensions of the adapter are contemplated, as is the number or configuration of the ports. The materials used for the components described herein may be the same as those typically used for fiber optic connection devices, such as molded plastics.

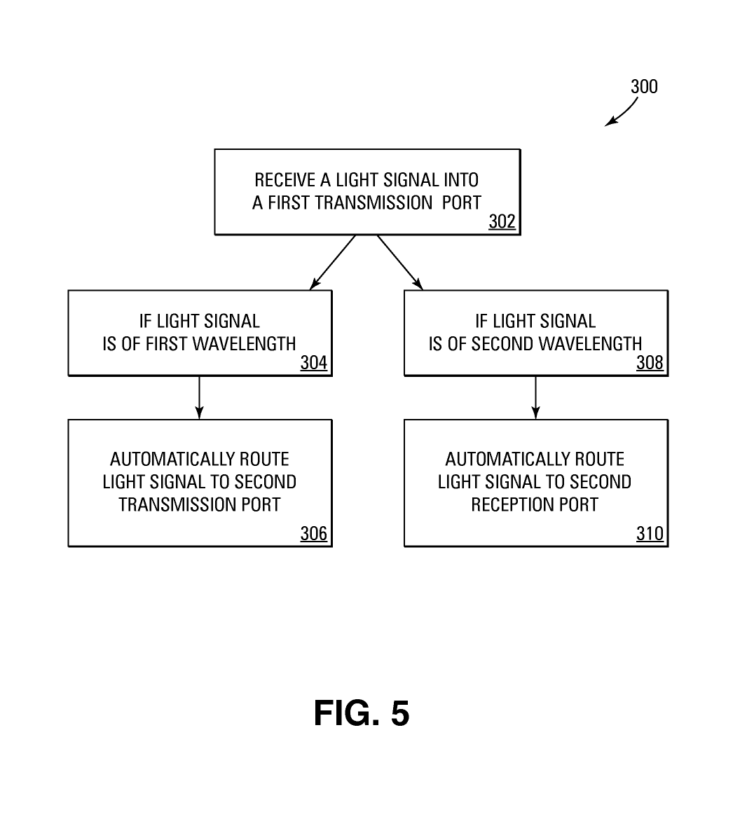

FIG. 5 depicts a method of passively testing a fiber optic circuit 300. The method may be practiced with a non-switched fiber optic loopback adapter, such as described herein. The method 300 begins at operation 302, by receiving a light signal into a first transmission port. At operation 304, if the light signal is of a first wavelength (such as a transmission signal typically used in data transmission), the light signal is routed automatically to a second transmission port, at operation 306. However, at operation 308, if the light signal is of a first wavelength (such as a test signal typically used in circuit testing), the light signal is routed automatically to a second reception port, at operation 310. Under either routing path, a non-switched optical device provides a pathway through which the light signal is routed automatically, without the need to actuate a switch.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A passive optical fiber loopback adapter comprising:
a first transmission port;
a second transmission port;
a first reception port;
a second reception port; and
a non-switched optical device, wherein the non-switched optical device is adapted to route a transmission light signal from the first transmission port to the second transmission port, and wherein the non-switched optical device is adapted to route a reception light signal from the first reception port to the second reception, and wherein the non-switched optical device is adapted to route a test light signal from the first transmission port to the second reception port.

2. The passive optical fiber loopback adapter of claim 1, wherein the non-switched optical device comprises a wavelength-division multiplexer.

3. The passive optical fiber loopback adapter of claim 1, wherein the non-switched optical device comprises an optical splitter.

4. The passive optical fiber loopback adapter of claim 1, wherein the transmission light signal and the reception light signal each comprise a wavelength of at least one of about 1310 nm and about 1550 nm.

5. The passive optical fiber loopback adapter of claim 1, wherein the test light signal comprises a wavelength of about 1625 nm.

6. The passive optical fiber loopback adapter of claim 1, wherein each of the first transmission port, the second transmission port, the first reception port, and the second reception port comprise a connector.

7. The passive optical fiber loopback adapter of claim 6, wherein each of the connectors comprises a split sleeve connector.

8. A optical fiber loopback adapter comprising:
a housing, wherein the housing comprises:
a non-switched optical device;
a first transmission port and a second transmission port, each connected to the non-switched optical device such that a transmission light signal directed into the first transmission port is routed to the second transmission port by the non-switched optical device; and
a first reception port and a second reception port, each connected to the non-switched optical device such that a reception light signal directed into the first reception port is routed to the second reception port by the non-switched optical device; and
wherein a test light signal directed into the first transmission port is routed to the second reception port by the non-switched optical device.

9. The optical fiber loopback adapter of claim 8, wherein the housing comprises a horizontal dimension and a vertical dimension, wherein each dimension is substantially similar to a corresponding dimension of a duplex SC adapter.

10. The optical fiber loopback adapter of claim 8, wherein the housing comprises a horizontal dimension and a vertical dimension, wherein each dimension is substantially similar to a corresponding dimension of a duplex LC adapter.

11. The optical fiber loopback adapter of claim 8, wherein the first reception port and the second transmission port are located on a rear portion of the housing, and wherein the second reception port and the first transmission port are located on a front portion of the housing.

12. The optical fiber loopback adapter of claim 8, wherein the transmission light signal and the reception light signal comprise a first wavelength, and the test light signal comprises a second wavelength different than the first wavelength.

13. A method of passively testing a fiber optic circuit with an optical fiber loopback adapter comprising a non-switched optical device, a first transmission port, a second transmission port, a first reception port, and a second reception port, the method comprising:
receiving a light signal via the first transmission port;
automatically routing the light signal to the second transmission port if the light signal comprises a first wavelength; and
automatically routing the light signal to the second reception port if the light signal comprises a second wavelength different from the first wavelength, wherein in both routing operations, the light signal is routed through the non-switched optical device.
